(19) United States
(12) Patent Application Publication
(10) Pub. No.: US 2024/0375560 A1
(43) Pub. Date: Nov. 14, 2024

(54) CONNECTION ADJUSTMENT MECHANISM AND CHILD CARRIER

(71) Applicant: Wonderland Switzerland AG, Steinhausen (CH)

(72) Inventor: Zongwang CHUI, Steinhausen (CH)

(21) Appl. No.: 18/294,622

(22) PCT Filed: Aug. 9, 2022
(86) PCT No.: PCT/EP2022/072364

§ 371 Date: Feb. 2, 2024

(30) Foreign Application Priority Data
Aug. 9, 2021 (CN) 202110910304.1

(51) Int. Cl. B60N 2/28

(52) U.S. Cl. CPC B60N 2/2839

(57) ABSTRACT

The present disclosure provides a connecting adjustment mechanism and a child carrier. The child carrier includes a sliding tube, a sliding assembly and an operating member. The sliding assembly includes a sliding member and a connecting member. The sliding member is slidably arranged on the sliding tube, the connecting member is movably arranged on the sliding member, and the connecting member is configured to be detachably cooperated with the seat. The operating member is movably arranged on the sliding member. When the operating member slides or rotates in a first direction, the connecting member is capable of sliding or rotating relative to the sliding member. When the operating member slides or rotates in a second direction opposite to the first direction, the sliding member is capable of sliding relative to the sliding tube. The connection adjustment mechanism and the child carrier are simple in structure and convenient to operate.

### CROSS REFERENCE TO RELATED APPLICATION

This application is an U.S. national phase application under 35 U.S.C § 371 based upon international patent application No. PCT/EP2022/072364, filed on Aug. 9, 2022, which itself claims priority to Chinese patent application 2021109103041, filed on Aug. 9, 2021. The contents of the above identified applications are hereby incorporated herein in their entireties by reference.

### TECHNICAL FIELD

The present disclosure relates to the technical field of child carrier, and in particular, to a connection adjustment mechanism and a child carrier.

### BACKGROUND

A child carrier, such as a child safety seat, is generally provided with a five-direction buckle or a protector. When the child is fixed by the protector, a contact area between the protector and the child is large. Thus, when the child is subjected to an accident such as a collision, the protector protects the child and at the same time produces less pressure on the child. However, the connection adjustment mechanism configured to connect the protector to the seat in the conventional child safety seat is relatively complicated in structure and inconvenient to operate.

### SUMMARY

A connection adjustment mechanism includes a sliding tube, a sliding assembly and an operating member. The sliding assembly includes a sliding member and a connecting member. The sliding member is slidably arranged on the sliding tube. The connecting member is movably arranged on the sliding member. The connecting member is configured to be detachably cooperated with a seat. The operating member is movably arranged on the sliding member. When the operating member slides or rotates in a first direction, the connecting member is capable of sliding or rotating relative to the sliding member. When the operating member slides or rotates in a second direction opposite to the first direction, the sliding member is capable of sliding relative to the sliding tube.

In one of the embodiments, the connecting member is pivotally connected to the sliding member, the operating member is slidably arranged on the sliding member and when the operating member slides in the first direction, the connecting member is capable of rotating relative to the sliding member.

In one of the embodiments, the sliding assembly further includes an adjustment member, and the adjustment member is pivotally connected to the sliding member. When the operating member slides in the second direction, the adjustment member is capable of rotating relative to the sliding member. The adjustment member has an adjustment portion, the sliding tube is provided with a plurality of positioning portions along an extending direction thereof, and the adjustment portion is detachably cooperated with the positioning portions.

In one of the embodiments, both ends of the operating member abut against the connecting member and the adjustment member respectively. When the operating member slides in the first direction, the connecting member rotates in a third direction relative to the sliding member. When the operating member slides in the second direction, the adjustment member rotates in a fourth direction relative to the sliding member. The third direction is opposite to the fourth direction. The sliding assembly further includes an elastic member, a middle part of the elastic member is fixed on the sliding member, and two ends of the elastic member abut against the connecting member and the adjustment member respectively. The elastic member makes the connecting member always have a tendency to rotate in the fourth direction, and the elastic member makes the adjustment member always have a tendency to rotate in the third direction.

In one of the embodiments, the elastic member includes a double torsion spring. Two central sleeves of the double torsion spring are fixed on the sliding member, and two ends of the double torsion spring abut against the connecting member and the adjustment member respectively.

In one of the embodiments, the positioning portions include a plurality of first female connecting portions arranged along the extending direction of the sliding tube. The adjustment portion includes a first male connecting portion detachably cooperated with the positioning portion. Alternatively, the positioning portions include a plurality of first male connecting portions arranged along the extending direction of the sliding tube, and the adjustment portion includes a first female connecting portion detachably cooperated with the positioning portion.

In one of the embodiments, the positioning portions include a plurality of positioning grooves arranged along the extending direction of the sliding tube, and the adjustment portion includes a positioning protrusion arranged on the adjustment member and is capable of being clamped into the positioning groove.

In one of the embodiments, at least two positioning protrusions are provided, and the at least two positioning protrusions can be simultaneously clamped into the at least two positioning grooves respectively.

In one of the embodiments, a side of the positioning protrusion abutting against a groove wall of the positioning groove has an inclined surface.

In one of the embodiments, the sliding member includes a sleeve portion and a sliding sheet portion that are connected to each other. The sleeve portion is arranged outside the sliding tube, and both the connecting member and the adjustment member are pivotally connected to the sliding sheet portion.

In one of the embodiments, the sliding assembly further includes a sliding housing. The sliding housing is slidably arranged on the sliding tube and is fixedly connected to the sliding member, and the sliding member, at least part of the connecting member and at least part of the operating member are arranged in the sliding housing.

A child carrier includes a protector, a seat and the aforementioned connection adjustment mechanism. The connection adjustment mechanism is disposed between the protector and the seat, so as to realize a detachable connection between the protector and the seat, and an adjustment of a seating space between the protector and the seat.

In one of the embodiments, the sliding tube of the connection adjustment mechanism is fixed on the protector, and the connecting member of the connection adjustment mechanism is detachably cooperated with the seat.

In one of the embodiments, the seat includes a connecting rod. The connecting rod is provided with a first connecting portion. The connecting member is provided with a second connecting portion capable of being detachably cooperated with the first connecting portion. The connecting rod has a first abutting surface, and the sliding assembly has a second abutting surface. When the first connecting portion is cooperated with the second connecting portion, the first abutting surface abuts against the second abutting surface.

In one of the embodiments, one of the first connecting portion and the second connecting portion is a second male connecting portion, and the other of the first connecting portion and the second connecting portion is a second female connecting portion detachably cooperated with the second male connecting portion.

In one of the embodiments, the first connecting portion 21c is an engaging hole, and the second connecting portion is an engaging hook detachably cooperated with the engaging hole.

In one of the embodiments, there are two connection adjustment mechanisms. The sliding tubes of the two connection adjustment mechanisms are fixed on both sides of the protector respectively, and the connecting members of the two connection adjustment mechanisms are detachably cooperated with both sides of the seat respectively.

The details of one or more embodiments of the present disclosure are set forth in the accompanying drawings and the description below. Other features, objects and advantages of the present disclosure will become apparent from the description, drawings and claims.

### BRIEF DESCRIPTION OF THE DRAWINGS

In order to better describe and illustrate the embodiments and/or examples of those applications disclosed herein, reference may be made to one or more of the accompanying drawings. The additional details or examples used to describe the drawings should not be considered to limit the scope of any of the disclosed applications, the presently described embodiments and/or examples, and the best mode of those applications presently understood.

FIG. 1 is a schematic diagram illustrating a child carrier according to an embodiment of the present disclosure, where a protector is mounted on a seat, and the protector is located close to the seat.

FIG. 2 is a schematic diagram illustrating the child carrier according to an embodiment of the present disclosure, where the protector is mounted on the seat, and the protector is located away from the seat.

FIG. 3 is a schematic diagram illustrating the protector and a connection adjustment mechanism in the child carrier shown in FIG. 1.

FIG. 4 is a schematic diagram illustrating the protector and the connection adjustment mechanism shown in FIG. 3 from another perspective.

FIG. 5 is a schematic diagram illustrating the protector and the connection adjustment mechanism shown in FIG. 3 omitting a cloth cover.

FIG. 6 is a schematic diagram illustrating the seat in the child carrier shown in FIG. 2.

FIG. 7 is a schematic diagram illustrating a base in the seat shown in FIG. 6.

FIG. 8 is a schematic diagram illustrating an inner support of the base shown in FIG. 7.

FIG. 9 is a schematic diagram illustrating a part of the configuration shown in FIG. 5.

FIG. 10 is an exploded view of a part of the configuration shown in FIG. 9.

FIG. 11 is a schematic diagram illustrating a sliding member in the connection adjustment mechanism shown in FIG. 10.

FIG. 12 is a schematic diagram illustrating a connecting member in the connection adjustment mechanism shown in FIG. 10.

FIG. 13 is a schematic diagram illustrating an adjustment member in the connection adjustment mechanism shown in FIG. 10.

FIG. 14 is a top view of the configuration shown in FIG. 9 omitting part of the sliding housing.

FIG. 15 is an enlarged view of portion A in FIG. 14.

### DESCRIPTION OF REFERENCE NUMERALS

10: protector; 11: first surface; 12: second surface; 13: longitudinal reinforcement; 14: transverse reinforcement; 15: cloth cover; 20: seat; 21: base; 22: backrest; 21a: base support; 21b: connecting rod; 21c: first connecting portion; 21d: first abutting surface; 30: connection adjustment mechanism; 100: sliding tube; 110: positioning portion; 210: sliding member; 211: sleeve portion; 212: sliding sheet portion; 212a: first penetration hole; 212b: second penetration hole; 212c: third penetration hole; 212d: fourth penetration hole; 213: bushing; 220: connecting member; 221: second connecting portion; 222: first mounting hole; 223: first protruding portion; 224: second protruding portion; 225: third protruding portion; 230: adjustment member; 231: adjustment portion; 231a: inclined surface; 232: second mounting hole; 233: fourth protrusion; 234: fifth protrusion; 240: elastic member; 241: spring coil; 242: end portion; 300: operating member; 400: sliding housing; 410: second abutting surface; D1: first direction; D2: second direction; D3: third direction; and D4: fourth direction.

### DETAILED DESCRIPTION OF THE EMBODIMENTS

In order to make the objectives, technical solutions and advantages of the present disclosure clearer, the present disclosure will be further described in detail below with reference to the accompanying drawings and specific embodiments. It should be understood that the specific embodiments described herein are only used to explain the present disclosure, and do not limit the protection scope of the present disclosure.

It should be understood that when an element is defined as “fixed to” another element, it is either directly on an element or indirectly on an element with a mediating element. When an element is considered to be “connected to” another element, it can be directly connected to another element or indirectly connected to another element with a mediating element. The terms “vertical”, “horizontal”, “left”, “right”, and the like used herein are for illustrative purposes only and are not intended to be the only embodiment.

Unless otherwise defined, all technical and scientific terms used herein have the same meaning as commonly understood by one of ordinary skill in the technical field to which the present disclosure belongs. The terms used herein in the specification of the present disclosure are for the purpose of describing particular embodiments only, and are not intended to limit the present disclosure. The term “and/or” used herein includes any and all combinations of one or more of the associated listed objects.

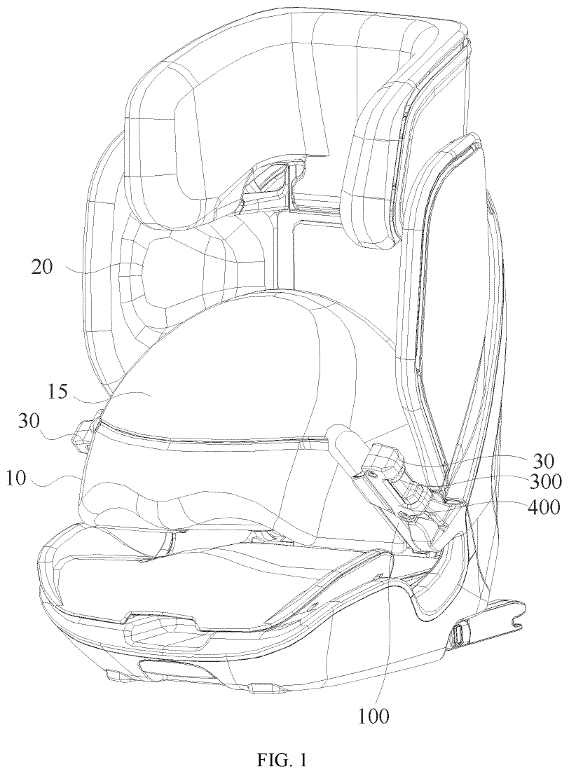

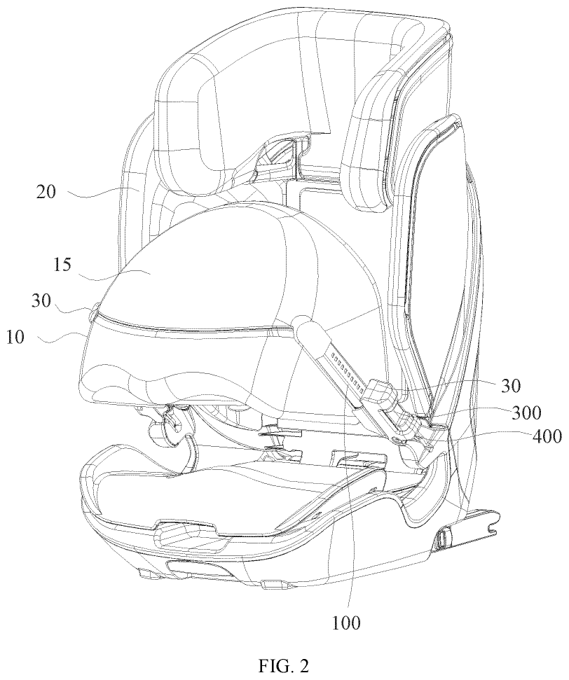

As shown in FIG. 1 and FIG. 2, an embodiment of the present disclosure provides a child carrier, such as a child safety seat. The child safety seat includes a protector 10, a seat 20 and a connection adjustment mechanism 30 arranged between the protector 10 and the seat 20. The connection adjustment mechanism 30 can realize a detachable connection between the protector 10 and the seat 20, and an adjustment of a seating space between the protector 10 and the seat 20. The connection adjustment mechanism 30 is simple in structure and convenient in operation.

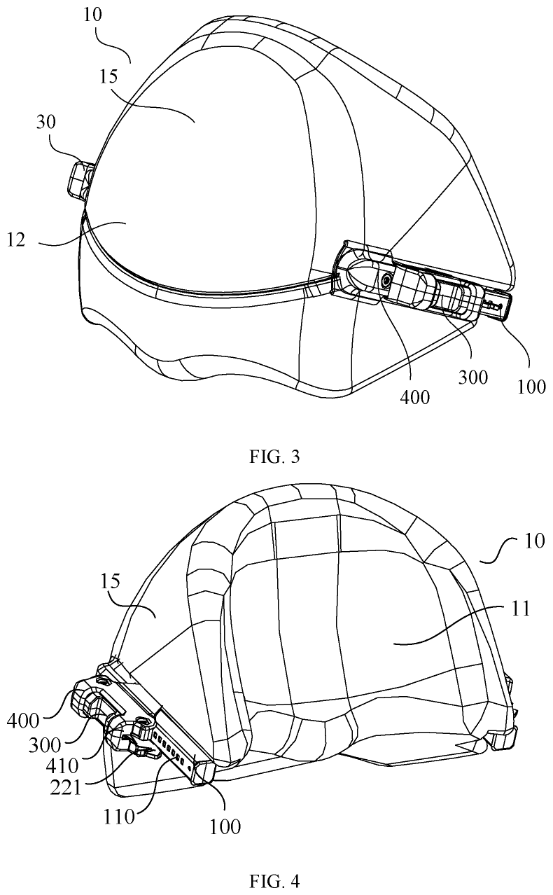

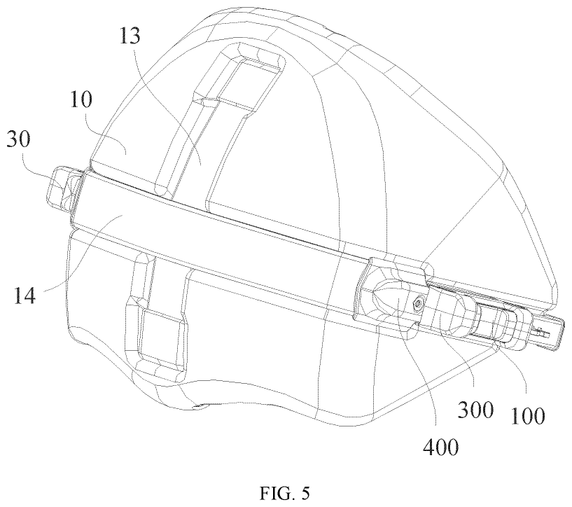

Specifically, as shown in FIGS. 3 to 5, the protector 10 may have a lightweight solid block structure or a housing structure made of foam materials such as expanded polystyrene (EPS), expanded polypropylene (EPP), or expanded polyethylene-polystyrene (EPO). In this embodiment, the protector 10 has a first surface 11 facing the seat 20, and the first surface 11 is concave, so as to surround and form a seating space for accommodating a child with the seat 20. The protector 10 also has a second surface 12 facing away from the seat 20, and the second surface 12 is convex and is generally partially spherical. As shown in FIG. 5, a longitudinal reinforcement 13 and a transverse reinforcement 14 are crosswise arranged on the second surface 12 to enhance a compressive strength of the protector 10. The protector 10 can be covered with a layer of flexible covering, such as a cloth cover 15 (as shown in FIG. 4), to prevent the user from being scratched by the longitudinal reinforcement 13 and transverse reinforcement 14 on a surface of the protector 10, and meanwhile the protector 10 is more pleasing to the eye.

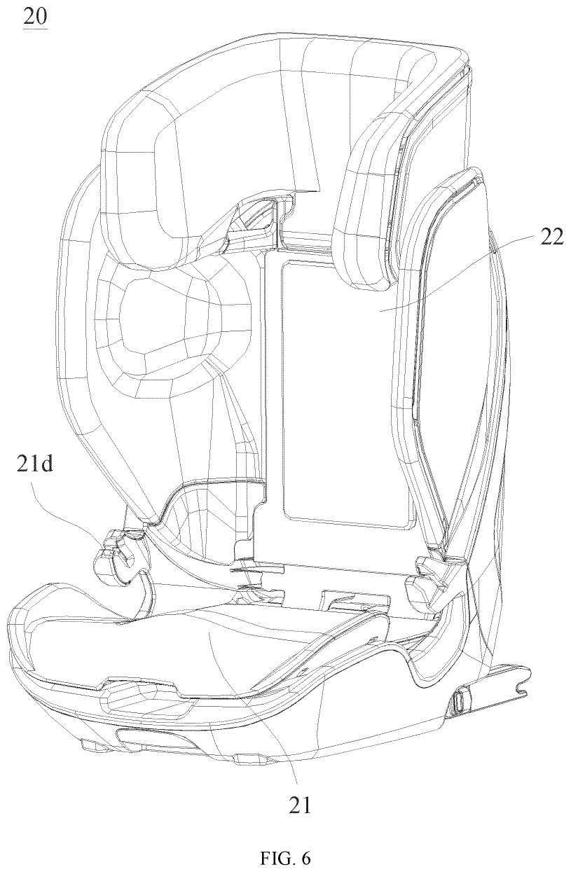

Specifically, as shown in FIGS. 6 to 8, the seat 20 includes a base 21 and a backrest 22 that are connected to each other, and the base 21 includes a base support 21a and a connecting rod 21b. The connecting rod 21b is inclined relative to the base support 21a, one end of the connecting rod 21b is fixed on the base support 21a by welding, and the other end of the connecting rod 21b is provided with a first connecting portion 21c and a first abutting surface 21d. In this embodiment, the base support 21a, the connecting rod 21b and the backrest 22 are all covered with a layer of seat covering to improve the riding comfort of the child, and the seat covering can be made of plastic material. Optionally, the seat cover covers the other end of the connecting rod 21b to form a first abutting surface 21d.

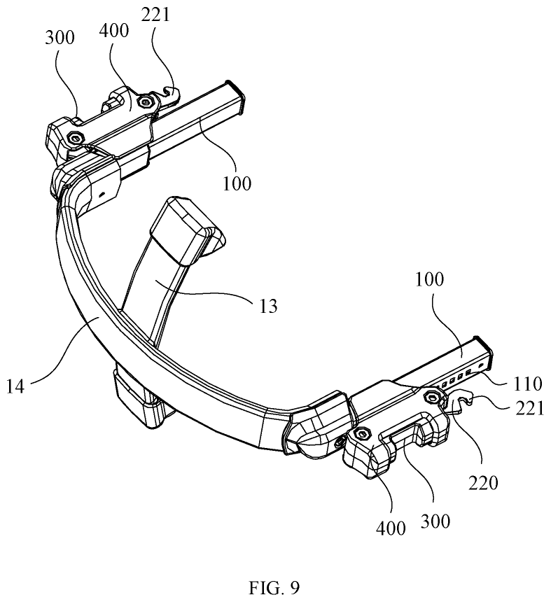

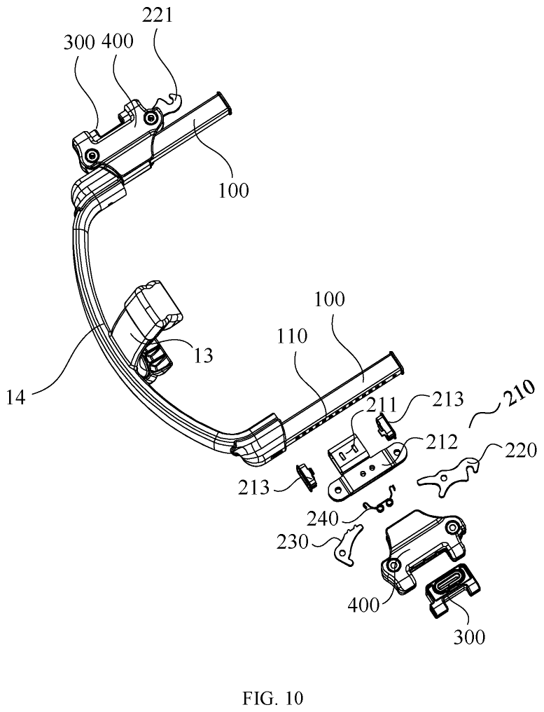

Specifically, as shown in FIGS. 9 and 10, the connection adjustment mechanism 30 includes a sliding tube 100, a sliding assembly, an operating member 300 and a sliding housing 400.

Optionally, as shown in FIGS. 4, 9 and 10, the sliding tube 100 is provided with a plurality of positioning portions 110 along an extending direction thereof, and one end of the sliding tube 100 is fixedly connected to the protector 10. In this embodiment, the transverse reinforcement 14 has a U-shaped tube structure, which is arranged along a transverse direction of the protector 10. One end of the sliding tube 100 is fixedly connected to an end of the transverse reinforcement 14.

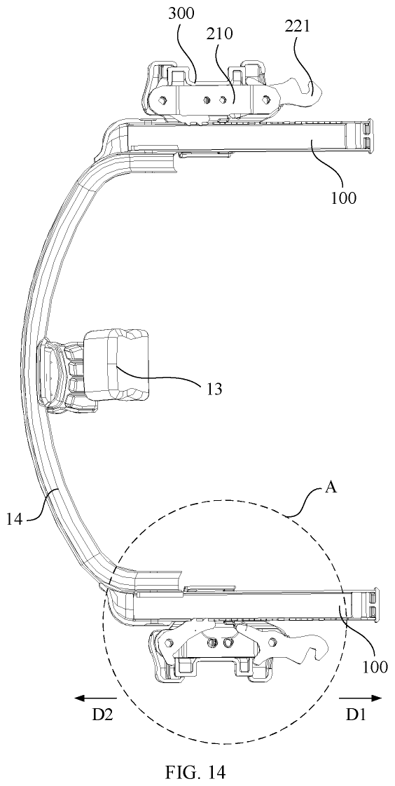

Specifically, as shown in FIGS. 10 to 14, the sliding assembly includes a sliding member 210, a connecting member 220, an adjustment member 230 and an elastic member 240. The sliding member 210 is slidably arranged on the sliding tube 100, and the connecting member 220 is movably arranged on the sliding member 210. The operating member 300 is movably disposed on the sliding member 210. When the operating member 300 slides or rotates in a first direction D1, the connecting member 220 is capable of sliding or rotating relative to the sliding member 210. When the operating member 300 slides or rotates in a second direction D2, the sliding member 210 is capable of sliding relative to the sliding tube 100. The first direction D1 is opposite to the second direction D2. In this embodiment, the operating member 300 is slidably arranged on the sliding member 210. The first direction D1 corresponds to a right direction in FIG. 14, and the second direction D2 corresponds to a left direction in FIG. 14. In other embodiments, the operating member 300 may also be pivotally connected to the sliding member 210.

Specifically, as shown in FIG. 11, the sliding member 210 includes a sleeve portion 211, a sliding sheet portion 212 and a bushing 213. The sleeve portion 211 and the sliding sheet portion 212 are connected to each other, and the sleeve portion 211 is arranged outside the sliding tube 100. The sliding sheet portion 212 is substantially elongated, and the sliding sheet portion 212 is provided with a first penetration hole 212a, a second penetration hole 212b, a third penetration hole 212c and a fourth penetration hole 212d in sequence along a length direction thereof. There are two bushings 213, both of which are arranged outside the sliding tube 100 and are fixedly connected to both sides of the sleeve portion 211 respectively.

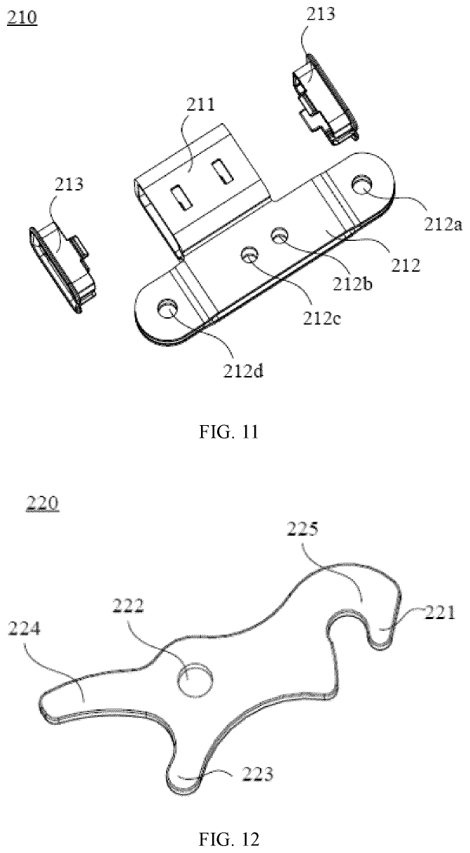

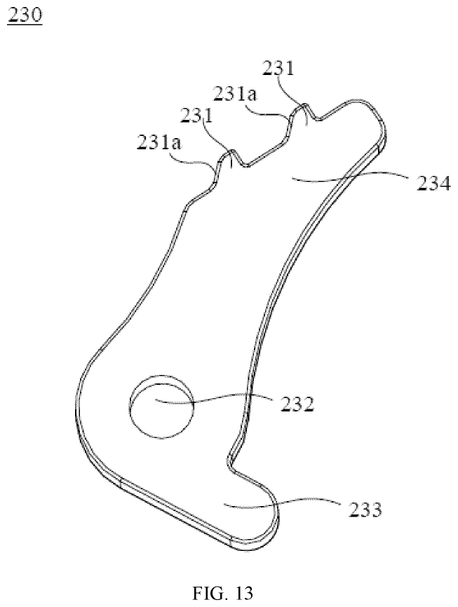

Further, referring to FIGS. 10, 14 and 15, the connecting member 220 and the adjustment member 230 are both pivotally connected to the sliding sheet portion 212 and arranged at intervals. Two ends of the operating member 300 abut against the connecting member 220 and the adjustment member 230 respectively. The connecting member 220 is provided with a second connecting portion 221 (as shown in FIG. 12) that is detachably cooperated with the first connecting portion 21c of the connecting rod 21b. The adjustment member 230 is provided with an adjustment portion 231 (as shown in FIG. 13) detachably connected to the positioning portions 110. When the operating member 300 slides in the first direction D1, the connecting member 220 rotates in a third direction D3 relative to the sliding member 210. When the operating member 300 slides in the second direction D2, the adjustment member 230 rotates in a fourth direction D4 relative to the sliding member 210. The third direction D3 and the fourth direction D4 may be, for example, counterclockwise and clockwise, respectively. A middle part of the elastic member 240 is fixed on the sliding member 210 and two ends thereof abut against the connecting member 220 and the adjustment member 230 respectively. The elastic member 240 makes the connecting member 220 always have a tendency to rotate in the fourth direction D4. The elastic member 240 makes the adjustment member 230 always has a tendency to rotate in the third direction D3.

In this embodiment, as shown in FIGS. 10, 14 and 15, the elastic member 240 includes a double torsion spring, and two spring coils 241 of the double torsion spring are fixed on the sliding sheet portion 212. In this embodiment, the sliding assembly further includes a first fixing pin (not shown) and a second fixing pin (not shown). The first fixing pin is inserted and fixed in the second penetration hole 212b (as shown in FIG. 11), the second fixing pin is inserted and fixed in the third penetration hole 212c (as shown in FIG. 11), and the two spring coils 241 are arranged on the first fixing pin and the second fixing pin respectively, so as to realize the fixing of the two spring coils 241 on the sliding member 210. Two ends 242 of the double torsion spring abut against the connecting member 220 and the adjustment member 230 respectively. In this way, the rotation of the connecting member 220 and the adjustment member 230 can be simultaneously driven by one operating member 300, so as to realize the dismounting between the seat 20 and the protector 10, and a size adjustment of the seating space between the seat 20 and the protector 10. The elastic member 240 makes the connecting member 220 or the adjustment member 230 return to an original position smoothly after being rotated, such that the connecting member 220 can be reconnected to the seat 20 and the adjustment member 230 can be reconnected to the sliding tube 100.

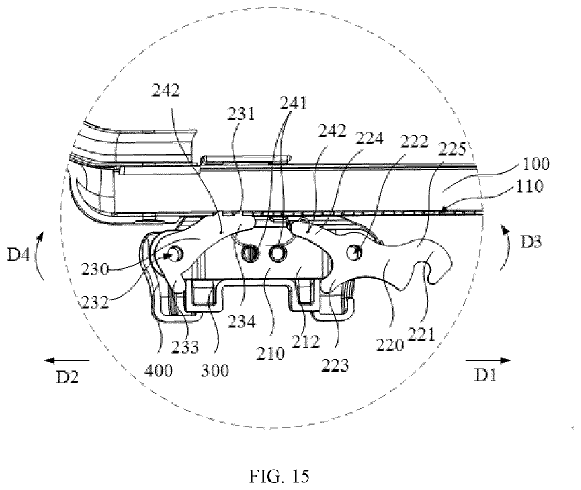

In this embodiment, as shown in FIG. 12, the connecting member 220 substantially has an irregular sheet-like structure, and includes a first protruding portion 223, a second protruding portion 224 and a third protruding portion 225. The connecting member 220 is provided with a first mounting hole 222, and the first protruding portion 223, the second protruding portion 224 and the third protruding portion 225 are arranged along a circumferential direction of the first mounting hole 222. Referring to FIGS. 11 and 15, the sliding assembly further includes a first rotating shaft (not shown), and the first rotating shaft passes through the first mounting hole 222 and the first penetration hole 212a to realize the pivot connection between the connecting member 220 and the sliding member 210. The first protruding portion 223 abuts against the operating member 300, the second protruding portion 224 abuts against an end portion 242 of the double torsion spring, and the third protruding portion 225 is provided with a second connecting portion configured to be detachably cooperated with the seat 20. Alternatively, the first protruding portion 223 and the second protruding portion 224 are located on a side of the first mounting hole 222 close to the adjustment member 230. The first protruding portion 223 is close to the operating member 300, and the second protruding portion 224 is close to the sliding tube 100. The third protruding portion 225 is located on a side of the first mounting hole 222 away from the adjustment member 230.

In this embodiment, as shown in FIG. 13, the adjustment member 230 generally has an irregular sheet-like structure, and includes a fourth protruding portion 233 and a fifth protruding portion 234. The adjustment member 230 is provided with a second mounting hole 232, and the fourth protruding portion 233 and the fifth protruding portion 234 are arranged along a circumferential direction of the second mounting hole 232. Referring to FIGS. 11 and 15, the sliding assembly further includes a second rotating shaft (not shown), and the second rotating shaft passes through the second mounting hole 232 and the fourth penetration hole 212d to realize the pivot connection between the adjustment member 230 and the sliding member 210. The fourth protruding portion 233 abuts against the operating member 300. The fifth protruding portion 234 abuts against the other end portion 242 of the double torsion spring. The fifth protruding portion 234 has an adjustment portion 231, and the adjustment portion 231 is detachably cooperated with the positioning portions 110. The fourth protruding portion 233 and the fifth protruding portion 234 are both located on a side of the second mounting hole 232 close to the connecting member 220. The fourth protruding portion 233 is close to the operating member 300, and the fifth protruding portion 234 is close to the sliding tube 100. The shape and the structure of the connecting member 220 and the adjustment member 230 may also be in other forms, such as irregular polygons, etc., as long as the aforementioned functions of dismounting between the seat 20 and the protector 10, and adjusting the size of the seating space between the seat 20 and the protector 10 can be realized.

Further, as shown in FIGS. 14 and 15, the sliding housing 400 is slidably arranged on the sliding tube 100 and is fixedly connected to the sliding member 210. The sliding member 210 and the adjustment member 230 are both arranged in the sliding housing 400. One part of the connecting member 220 is arranged in the sliding housing 400, and the other part of the connecting member 220 having the second connecting portion 221 protrudes from an opening of the sliding housing 400 so as to cooperate with the first connecting portion 21c of the connecting rod 21b. One part of the operating member 300 is located outside the sliding housing 400 for the user to operate, and the other part of the operating member 300 extends into the sliding housing 400 through another opening of the sliding housing 400 and is slidably connected to the sliding member 210. The sliding housing 400 is provided to protect the various components of the sliding assembly from being damaged and fell off, and can also prevent some sharp components from scratching the user.

Optionally, as shown in FIGS. 4 and 6, the first connecting rod 21b has a first abutting surface 21d, and the sliding assembly has a second abutting surface 410. When the first connecting portion 21c is cooperated with the second connecting portion 221, the first abutting surface 21d abuts against the second abutting surface 410. In this embodiment, the second abutting surface 410 is arranged on a side of the sliding housing 400 close to the second connecting portion 221 (as shown in FIGS. 14 and 15).

Optionally, as shown in FIGS. 13 and 15, the positioning portions 110 may include a plurality of first female connecting portions arranged along the extending direction of the sliding tube 100, and the adjustment portion 231 may include a first male connecting portion detachably cooperated with the positioning portions 110. Alternatively, the positioning portions 110 may include a plurality of first male connecting portions arranged along the extending direction of the sliding tube 100, and the adjustment portion 231 may include a first female connecting portion detachably cooperated with the positioning portions 110.

In this embodiment, as shown in FIGS. 13 and 15, the positioning portions 110 include a plurality of positioning grooves arranged along the extending direction of the sliding tube 100, and the adjustment portion 231 include a positioning protrusion disposed on the adjustment member 230 which is capable of being clamped into the positioning groove. When the positioning protrusions are clamped into different positioning grooves, the sliding assembly is located on different positions on the sliding tube 100. If the first connecting portion 21c and the second connecting portion 221 are cooperated at this time, the sliding assembly and the seat 20 are relatively fixed. The protector 10 moves to positions which has different distances from the seat 20 along with the sliding tube 100, so as to realize the adjustment of the seating space between the protector 10 and the seat 20, and the cooperation structure of the positioning groove and the positioning protrusion is relatively simple and easy to implement. In other embodiments, the positioning portions 110 may include a plurality of positioning protrusions, and the adjustment portion 231 may correspondingly include a positioning groove, which is not limited. Alternatively, the positioning portions 110 may include a plurality of positioning rings provided along the extending direction of the sliding tube 100, and the adjustment portion 231 may include a positioning hook arranged on the connecting member 220.

Optionally, at least two positioning protrusions are provided, and the at least two positioning protrusions can be simultaneously clamped into the at least two positioning grooves respectively. As such, the cooperation and connection between the adjustment member 230 and the sliding tube 100 can be more stable. The number of positioning protrusions can be set to more than two or less than two according to the actual situation.

Further, as shown in FIG. 13 and FIG. 15, a side of the positioning protrusion abutting against a groove wall of the positioning groove has an inclined surface 231a. Accordingly, when the protector 10 moves toward or away from the seat 20, the user can directly push the protector 10 without operating the operating member 300, which makes the operation more convenient. For example, an inclined surface 231a is arranged on a side of the positioning protrusion close to the protector 10, and the inclined surface 231a is inclined in a way that the inclined surface 231a gradually approaches the seat 20 in a direction away from the operating member 300. As such, when the protector 10 is adjusted in a direction close to the seat 20, it is not necessary to operate the operating member 300, and the protector 10 can be directly pushed by the user in the direction close to the seat 20.

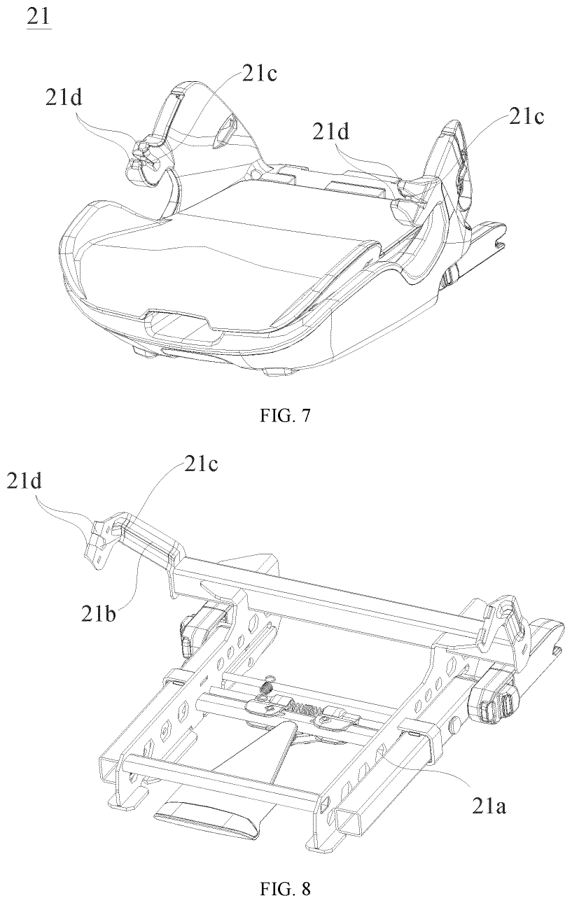

Alternatively, as shown in FIGS. 7, 13 and 15, one of the first connecting portion 21c and the second connecting portion 221 is a second male connecting portion, and the other of the first connecting portion 21c and the second connecting portion 221 is a second female connecting portion detachably cooperated with the second male connecting portion.

In this embodiment, as shown in FIGS. 7, 13 and 15, the first connecting portion 21c is an engaging hole, and the second connecting portion 221 is an engaging hook detachably cooperated with the engaging hole. Through the detachable cooperation between the engaging hook and the engaging hole, the mounting and dismounting between the protector 10 and the seat 20 can be realized. In this way, the connection is stable, the structure is simple, and it is easy to implement. Alternatively, the first connecting portion 21c may be an engaging hook, and the second connecting portion 221 may be an engaging hole correspondingly, which is not limited herein.

Optionally, as shown in FIGS. 1 and 9, two connection adjustment mechanisms 30 are provided. The sliding tubes 100 of the two connection adjustment mechanisms 30 are fixed on both sides of the protector 10 respectively, and the connecting members of the two connection adjustment mechanisms 30 are detachably cooperated with two sides of the seat 20 respectively, so as to facilitate the simultaneous adjustment of the positions of the protector 10. The number of connection adjustment mechanisms 30 may also be less than two or more than two, which can be set according to actual needs, which is not limited herein.

The aforementioned connection adjustment mechanism 30 and the child carrier have the following beneficial effects.

The aforementioned connection adjustment mechanism 30 can be applied to the child carrier, the sliding tube 100 can be fixed on the protector 10, and the connecting member 220 can be detachably cooperated with the seat 20. When the operating member 300 moves (slides or rotates) in the first direction D1, the connecting member 220 is capable of moving (sliding or rotating) relative to the sliding member 210. As such, the connecting member 220 is capable of moving to switch between states of being engaged with or disengaged from the seat 20, such that the detachable cooperation of the protector 10 and the seat 20 can be realized. When the operating member 300 moves (slides or rotates) in the second direction D2, the sliding member 210 and the sliding tube 100 can slide relative to each other. At this time, if the connecting member 220 pivotally connected to the sliding member 210 is in the cooperation state with the seat 20, the protector 10 is capable of moving toward or away from the seat 20 with the sliding of the sliding tube 100, that is, the adjustment of the seating space between the protector 10 and the seat 20 can be realized. As such, functions of mounting and dismounting of the protector 10 and adjustment of the seating space can be realized by one operating member 300, and the structure is simple and the operation is convenient.

In another embodiment, the function of the operating member 300 can also be implemented via two operating members, one of which is configured to drive the connecting member 220 such that the protector 10 and the seat 20 can cooperate with or separate from each other, and the other of which is configured to drive the adjustment component 230 such that the seating space between the seat 20 and the protector 10 can be adjusted adaptively.

The technical features of the aforementioned embodiments may be combined arbitrarily. To simplify the description, not all the possible combinations of the technical features in the aforementioned embodiments are described. However, all of the combinations of these technical features should be considered as within the scope of the present disclosure, as long as such combinations do not contradict with each other.

The above embodiments merely illustrate several embodiments of the present disclosure, and the description thereof is specific and detailed, but it shall not be constructed as limiting the scope of the disclosure. It should be noted that, for a person of ordinary skill in the art, several variations and improvements may be made without departing from the concept of the present disclosure, and these are all within the protection scope of the present disclosure. Therefore, the protection scope of the present disclosure shall be subject to the appended claims.

1. A connection adjustment mechanism, comprising
a sliding tube;
a sliding assembly comprising a sliding member and a connecting member, wherein the sliding member is slidably arranged on the sliding tube, the connecting member is movably arranged on the sliding member, and the connecting member is configured to be detachably cooperated with a seat; and
an operating member movably arranged on the sliding member, wherein, when the operating member slides or rotates in a first direction, the connecting member is capable of sliding or rotating relative to the sliding member, and when the operating member slides or rotates in a second direction opposite to the first direction, the sliding member is capable of sliding relative to the sliding tube.

2. The connection adjustment mechanism according to claim 1, wherein the connecting member is pivotally connected to the sliding member, the operating member is slidably arranged on the sliding member and when the operating member slides in the first direction, the connecting member is capable of rotating relative to the sliding member.

3. The connection adjustment mechanism according to claim 1, wherein the sliding assembly further comprises an adjustment member, the adjustment member is pivotally connected to the sliding member, when the operating member slides in the second direction, the adjustment member is capable of rotating relative to the sliding member, the adjustment member has an adjustment portion, the sliding tube is provided with a plurality of positioning portions along an extending direction thereof, and the adjustment portion is detachably cooperated with the positioning portions.

4. The connection adjustment mechanism according to claim 3, wherein both ends of the operating member abut against the connecting member and the adjustment member respectively, when the operating member slides in the first direction, the connecting member rotates in a third direction relative to the sliding member, when the operating member slides in the second direction, the adjustment member rotates in a fourth direction relative to the sliding member, the third direction is opposite to the fourth direction, the sliding assembly further comprises an elastic member, a middle part of the elastic member is fixed on the sliding member, two ends of the elastic member abut against the connecting member and the adjustment member respectively, and the elastic member is capable of driving the connecting member to rotate in the fourth direction and the adjustment member to rotate in the third direction.

5. The connection adjustment mechanism according to claim 4, wherein the elastic member comprises a double torsion spring, two central sleeves of the double torsion spring are fixed on the sliding member, and two ends of the double torsion spring abut against the connecting member and the adjustment member, respectively.

6. The connection adjustment mechanism according to claim 3, wherein the positioning portions comprise a plurality of first female connecting portions arranged along the extending direction of the sliding tube, and the adjustment portion comprises a first male connecting portion detachably cooperated with the positioning portion; or
wherein the positioning portions comprise a plurality of first male connecting portions arranged along the extending direction of the sliding tube, and the adjustment portion comprises a first female connecting portion detachably cooperated with the positioning portion.

7. The connection adjustment mechanism according to claim 3, wherein the positioning portions comprise a plurality of positioning grooves arranged along the extending direction of the sliding tube, the adjustment portion comprises a positioning protrusion arranged on the adjustment member, and the positioning protrusion is adapted to be clamped into the positioning groove.

8. The connection adjustment mechanism according to claim 7, wherein at least two positioning protrusions capable of being simultaneously clamped into at least two positioning grooves, respectively, are provided.

9. The connection adjustment mechanism according to claim 7, wherein a side of the positioning protrusion abutting against a groove wall of the positioning groove has an inclined surface.

10. The connection adjustment mechanism according to claim 3, wherein the sliding member comprises a sleeve portion and a sliding sheet portion that are connected to each other, the sleeve portion is arranged outside the sliding tube, and both the connecting member and the adjustment member are pivotally connected to the sliding sheet portion.

11. The connection adjustment mechanism according to claim 1, wherein the sliding assembly further comprises a sliding housing, the sliding housing is slidably arranged on the sliding tube and is fixedly connected to the sliding member, and the sliding member, at least part of the connecting member and at least part of the operating member are arranged in the sliding housing.

12. A child carrier, comprising a protector, a seat and the connection adjustment mechanism according to claim 1, wherein the connection adjustment mechanism is provided to realize a detachable connection between the protector and the seat, and an adjustment of a seating space between the protector and the seat.

13. The child carrier according to claim 12, wherein the sliding tube of the connection adjustment mechanism is fixed on the protector, and the connecting member of the connection adjustment mechanism is detachably cooperated with the seat.

14. The child carrier according to claim 12, wherein the seat comprises a connecting rod, the connecting rod is provided with a first connecting portion, the connecting member is provided with a second connecting portion capable of being detachably cooperated with the first connecting portion, the connecting rod has a first abutting surface, the sliding assembly has a second abutting surface, and when the first connecting portion is cooperated with the second connecting portion, the first abutting surface abuts against the second abutting surface.

15. The child carrier according to claim 14, wherein one of the first connecting portion and the second connecting portion is a second male connecting portion, and the other of the first connecting portion and the second connecting portion is a second female connecting portion detachably cooperated with the second male connecting portion.

16. The child carrier according to claim 14, wherein the first connecting portion is an engaging hole, and the second connecting portion is an engaging hook detachably cooperated with the engaging hole.

17. The child carrier according to claim 12, wherein two connection adjustment mechanisms are provided, the sliding tubes of the two connection adjustment mechanisms are fixed on both sides of the protector, respectively, and the connecting members of the two connection adjustment mechanisms are detachably cooperated with both sides of the seat, respectively.
